(19) United States
(12) Patent Application Publication
(10) Pub. No.: US 2006/0259536 A1
(43) Pub. Date: Nov. 16, 2006

(54) Integer transforming device for moving-picture encoder

(76) Inventors: Eon-Pyo Hong, Gwangyang-si (KR); Dong-Soo Har, Gwangju (KR); Jeong-A Lee, Gwangju (KR); Hyun-Sup Shin, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/397,763

(22) Filed: Apr. 3, 2006

(30) Foreign Application Priority Data
Apr. 13, 2005 (KR) 10-2005-0030693

(51) Int. Cl. G06F 7/50

(52) U.S. Cl. 708/670

(57) ABSTRACT

An integer transforming device for a moving-picture compression encoder, associated with the H.264 standard, comprising: a first adding/subtracting stage including pluralities of adders/subtracters to execute addition and subtraction for input data, generating data extended by a predetermined bit number; a second adding/subtracting stage including pluralities of adders/subtracters to execute addition and subtraction for a shifted result of output data of the first adding/subtracting stage, generating data extended by a predetermined bit number; a third adding/subtracting stage including pluralities of adders/subtracters to execute addition and subtraction for an operation result of the second adding/subtracting stage, generating data extended by a predetermined bit number; and a fourth adding/subtracting stage including pluralities of adders/subtracters to execute addition and subtraction for a shifted result of the third adding/subtracting stage, generating data extended by a predetermined bit number.

### CROSS-REFERENCE TO RELATED APPLICATION

This application claims priority under 35 U.S.C. §119(a) from Republic of Korea Patent Application No. 10-2005-0030693, filed on Apr. 13, 2005, which is herein incorporated by reference.

### BACKGROUND OF THE INVENTION

1. Field of the Invention

The present invention relates to an integer transforming devices. In particular, the present invention relates to an integer transforming device conducting an integer transforming operation for predicted errors in moving-picture compression technology such as H.264.

2. Description of the Related Art

Digital multimedia networking technologies are rapidly improving with a wide range of services being provided. When providing a communication service by means of digital moving picture, it is necessary to compress the data or use lines with large capacity. Until now, there have been various standards for moving-picture compression, e.g., MPEG-1. MPEG-2, MPEG-4, H.261, H.263, and so forth. These are unsuitable for multimedia oriented toward lower bit rates, such as wireless devices which have become popular recently. Thus, further efficient ways of compression are required.

The H.264 standard is also called the MPEG-4 AVC (Advanced Video Coding) standard. This is a standard of picture compression technology developed in collaboration with ITU-T and ISO/IEC, which is applicable to all kinds of picture applications and is also capable of transmitting moving pictures on DVD level through the internet while consuming less network resources than other standards of moving-picture compression. Moreover, the H.264 standard is able to raise a compression rate up to 50% higher in almost all bit-rate conditions, providing high-quality images and advantages in error restoration and network transplantation.

Video CODECs (coder and decoder) are mostly employed in mobile communication terminals such as digital cameras, digital camcorders, camera phones, portable multimedia players, and so on, in which it is necessary to transmit the least amount of data possible to satisfy the required image quality, and using the least possible bandwidth. Reducing bandwidth is helpful in accomplishing transmission with different picture streams, image quality enhancement, transmission power reduction, and error restoration enhancement. Therefore, the H.264 standard is regarded as being the most adaptable to encoding pictures in the application of digital communications with wireless pictures.

However, the H.264 standard is regarded as being more complicated and slower than other standards of picture compression, as well as consuming a lot of power and difficulty in processing with real time. This problem particularly grows heavier in processing an integer transforming.

FIG. 1 is a schematic diagram illustrating a configuration of an integer transforming device employed in a general H.264 encoder.

The compression by the H.264 standard is carried out in a unit of 4×4 picture blocks, using an integer transforming scheme originating from the 4×4 DCT (Discrete Cosine Transform).

The integer transforming device of FIG. 1, is constructed with a cascade architecture consisting of two blocks, each of which includes four integer transforming units. Each integer transforming unit is composed of 4 adders and 4 subtracters, in which a shifting operation is accomplished by means of a wired hardware structure. In detail, the integer transforming device is comprised of: a first adding/subtracting stage 1, executing addition and subtraction for input data; a second adding/subtracting stage 2, executing addition and subtraction for a shift operation result of the first adding/subtracting stage 1; a third adding/subtracting stage 3, executing addition and subtraction for an operation result of the second adding/subtracting stage 2; and a fourth adding/subtracting stage 4, executing addition and subtraction for a shift operation result of the third adding/subtracting stage 3. Each of the first through fourth adding/subtracting stage s 1˜4 consists of 8 adders and 8 subtracters.

Such an integer transforming device usually requires 32 16-bit adders and 32 16-bit subtracters in prosecuting integer transformation for 16-bit pixel data.

The integer transforming device as shown in FIG. 1 has an advantage of greatly improving data processing speed and reducing power consumption, although many logic gates are required. Here, the input data for integer transformation is configured in the range from −255 to +255 for a pixel, and composed of 9 bits in the form of 2's complement. As a result, since the 16-bit adders and subtracters are adopted throughout while using the integer transforming device shown in FIG. 1, it is inevitable that hardware complexity is increased and data processing speed is diminished.

### SUMMARY OF THE INVENTION

The present invention is directed at solving the aforementioned problems and shortcomings, providing an integer transforming device of an H.264 encoder which is optimized in hardware architecture without unnecessary elements therein.

An aspect of the present invention is to provide an integer transforming device for a moving-picture compression encoder, associated with the H.264 standard, comprising: a first adding/subtracting stage including pluralities of adders/subtracters to execute addition and subtraction for input data, generating data extended by a predetermined bit number; a second adding/subtracting stage including pluralities of adders/subtracters to execute addition and subtraction for a shifted result of output data of the first adding/subtracting stage, generating data extended by a predetermined bit number; a third adding/subtracting stage including pluralities of adders/subtracters to execute addition and subtraction for an operation result of the second adding/subtracting stage, generating data extended by a predetermined bit number; and a fourth adding/subtracting stage including pluralities of adders/subtracters to execute addition and subtraction for a shifted result of the third adding/subtracting stage, generating data extended by a predetermined bit number.

### BRIEF DESCRIPTION OF THE DRAWINGS

The accompanying figures are included to provide a further understanding of the invention, and are incorporated in and constitute a part of this specification. The drawings illustrate example embodiments of the present invention and, together with the description, serve to explain the principles of the present invention. In the figures:

FIG. 1 is a schematic diagram illustrating a configuration of an integer transforming device employed in a general H.264 encoder;

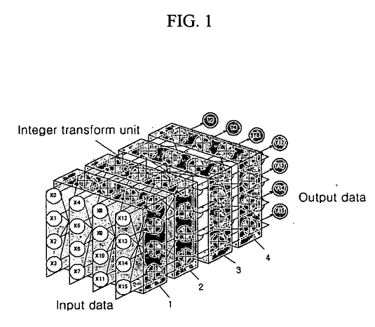

FIG. 2 is a block diagram showing a moving-picture compression encoder based on the H.264 standard;

FIG. 3 is a block diagram illustrating an integer transforming device for an H.264 moving-picture encoder in accordance with the present invention;

FIG. 4 is a circuit diagram illustrating a bit-extension adder applicable to the present invention; and

FIG. 5 is a circuit diagram illustrating a bit-extension subtracter applicable to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, an exemplary embodiment of the present invention will be described in conjunction with the accompanying drawings.

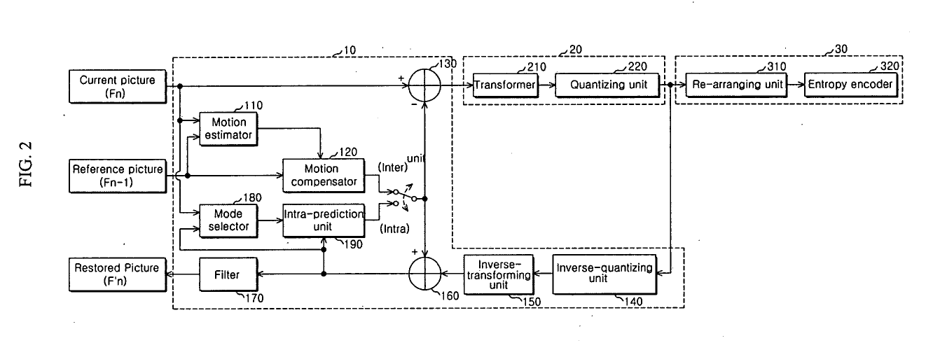

FIG. 2 is a block diagram showing a moving-picture compression encoder based on the H.264 standard.

As illustrated in FIG. 2, the H.264 moving-picture compression encoder is composed of a prediction module 10, a transforming and quantizing module 20, and an entropy coding module 30.

The prediction module 10 conducts operations of inter-prediction and intra-prediction. Inter-prediction means predicting a block of a current picture with regard to a reference picture which is stored in a buffer after being decoded and passed through a de-blocking filtering process. In other words, the inter-prediction executes prediction by means of information among pictures. The inter-prediction is carried out in a motion estimator 110 and a motion compensator 120 so as to prevent duplication between subsequent frames. An output signal from the motion compensator 120 is applied to the transforming and quantizing module 20 after being combined with a current picture by a first combination unit 130.

In addition, the intra-prediction, as a process for lessening spatial duplication in frames, enhances compression efficiency by conducting the prediction step before integer transformation. To achieve this, an adjacent block, which has been already coded, is decoded through an inverse-quantizing unit 140 and an inverse-transforming unit 150, and the decoded block is inputted to a mode selector 180 and an intra-prediction unit 190. The intra-prediction unit 190 generates a result of spatial prediction in accordance with output signals from the mode selector 180 and the inverse-transforming unit 150.

Data, for which the intra-prediction has been completed, is generated as a restored picture after being combined with the output signal of the inverse-transforming unit 150 by a second combination unit 160 and being eliminated noises by a filter 170.

Meanwhile, a transformer 210 of the transforming and quantizing module 20 performs an integer transforming operation for an erroneous picture, which is extant in a prediction sample output from the prediction module 10, in the unit of 4×4 blocks. A quantizing unit 22Q compresses an output signal of the transformer 210 with quantization. The transformer 210 may be implemented into the integer transforming device according to the present invention, as described later in detail.

The entropy coding module 30 is comprised of a re-arranging unit 310 and an entropy encoder 320, coding (or encoding) quantized picture data, on the basis of probability set by occurrence frequencies of symbols, under a predetermined method.

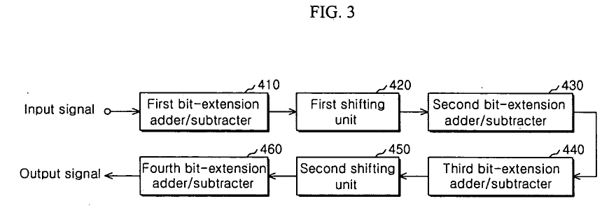

FIG. 3 is a block diagram illustrating an integer transforming device for an H.264 moving-picture encoder in accordance with the present invention, showing a data processing flow through an adder (or a subtracter) included in each adding/subtracting stage.

As stated above, the integer transforming device is comprised of two blocks each having 4 integer transforming units. Each integer transforming unit is composed of 4 adders and 4 subtracters, in which a shifting operation is accomplished by means of a wired hardware structure. The integer transforming device is comprised of: a first adding/subtracting stage executing addition and subtraction for input data; a second adding/subtracting stage executing addition and subtraction for a shifted result of the first adding/subtracting stage; a third adding/subtracting stage executing addition and subtraction for an operation result of the second adding/subtracting stage; and a fourth adding/subtracting stage executing addition and subtraction for a shifted result of the third adding/subtracting stage. Each adding/subtracting stage consists of 8 adders and 8 subtracters.

In the H.264 moving-picture compression encoder, input data of the integer transforming device is pixel data divided into macro blocks. As the pixel data is valued in the range from −255 to +255, it is represented with 9 bits in the form of 2's complement. Thus, a first bit-extension adder/subtracter 410 of the first adding/subtracting stage generates 10-bit data that is extended from the 9-bit pixel data by 1-bit which used as carry or borrow. The 10-bit output data is further extended by through a left-shifting operation by a first shifting unit 420 that is implemented with a wired hardware structure, and then applied to a second bit-extension adder/subtracter 430 of the second adding/subtracting stage. Then, 12-bit data is outputted as a result. The 12-bit data is further extended by a predetermined bit number when it passes passing through a third bit-extension adder/subtracter 440 of the third adding/subtracting stage, a second shifting unit 450, and a fourth bit-extension adder/subtracter 460 of the fourth adding/subtracting stage, resulting in 15-bit pixel data. The increment bit number may be set on 1 at least in every adder/subtracter, in which a bit number of output data to input data increases as an integer times as large as [the number of the adders/subtracters+the number of the shifting units]. When the data is extended by 1-bit every stage, the output data is generated with an extension of 6 bits more than the input data because the number of the adders/subtracters and the shifting units, being included in the integer transforming device shown in FIG. 3, is 6.

In other words, it is unnecessary to implement the adders and subtracters with the same structure because the adders and subtracters of each adding/subtracting stage do not treat the same bit-numbered data. Thus, the present invention is configured such that the integer transformation is accomplished by way of outputting data with n+the predetermined bit number (e.g., 1) from n-bit input data. As a result, the first, second, third, and fourth adding/subtracting units are implemented with a 9-bit-input/10-bit-output adder/subtracter, an 11-bit-input/12-bit-output adder/subtracter, a 12-bit-input/13-bit-output adder/subtracter, and a 14-bit-input/15-bit-output adder/subtracter, respectively. The shifting unit may be implemented in a wired hardware structure.

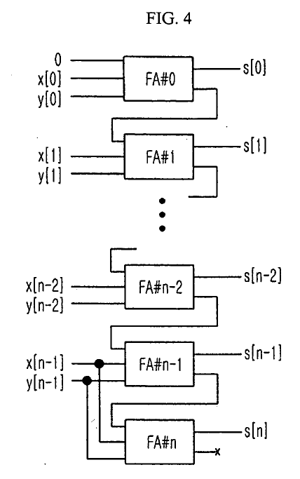

FIG. 4 is a circuit diagram illustrating a bit-extension adder applicable to the present invention.

As shown in FIG. 4, the bit-extension adder is composed of full adders FA#0 ˜FA#n. Each full adder receives a carry of the prior full adder and first and second data bits to be added, and then outputs a sum S and a carry. Especially, the first full adder FA#0 receives 0 as a carry input, while the last full adder FA#n operates with an output carry from the prior full adder FA#n−1 and input data bits which are also input to the prior full adder FA#n−1.

As such, it is possible to obtain an output signal, which is formed of n+1 bits, by way of the adding operation using the n+1 full adders for the n-bit input signal.

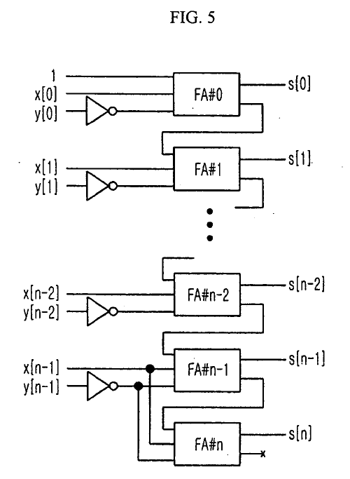

FIG. 5 is a circuit diagram illustrating the bit-extension subtracter applicable to the present invention.

As shown in FIG. 5, the bit-extension subtracter is composed of full adders FA#0˜FA#n. Each full adder receives a carry of the prior full adder and first and second data bits to be added, and then outputs a sum S and a carry. Especially, the first full adder FA#0 receives 1 as a carry input, while the last full adder FA#n uses an output carry from the prior full adder FA#n−1 and input data bits which are also input to the prior full adder FA#n−1.

As such, it is possible to obtain an output signal, which is formed of n+1 bits, by way of the subtracting operation using the n+1 full adders for the n-bit input signal.

The following Table 1 arranges encoding times by the H.264 moving-picture compression encoder in the case of using the conventional 1-dimension (1-D) integer transforming device of the cascade type and the transforming device of the present invention.

TABLE 1

| | Conventional 1-D integer | Present |
|---|---|---|
| | transforming device of cascade | transforming |
| | type | device |
| Slice number | 881 | 670 |
| Processing time (□) | 6.669 | 5.616 |

In order to determine a degree of improvement in the performance of the encoding operation when applying the transformer of the present invention, Xilinx Project Navigator is utilized to organize the transformer of the present invention, implementing the Xilinx Virtex 2-Pro (xc2vp100-5) FPGA chip. The FPGA used therein includes 100K logic cells, each logic cell being composed of 44,096 slices having a gate capacity of about 6000K. As can be seen from Table 1, the present invention reduces the number of slices by 25% from the conventional scheme and increases the data processing speed by 16% from the conventional case.

According to the present invention, it is able to decrease the hardware complexity in implementing the H.264 moving-picture compression encoder, as well as enhancing the processing speed and reducing power consumption. Moreover, it lowers the unit cost by eliminating unnecessary circuit components.

Although the present invention has been described in connection with the embodiment of the present invention illustrated in the accompanying drawings, it is not limited thereto. It will be apparent to those skilled in the art that various substitutions, modifications, and changes may be made without departing from the scope and spirit of the invention.

What is claimed is:

1. An integer transforming device for a moving-picture compression encoder, associated with the H.264 standard, comprising:
a first adding/subtracting stage including pluralities of adders/subtracters to execute addition and subtraction for input data, generating data extended by a predetermined bit number;
a second adding/subtracting stage including pluralities of adders/subtracters to execute addition and subtraction for a shifted result of output data of the first adding/subtracting stage, generating data extended by a predetermined bit number;
a third adding/subtracting stage including pluralities of adders/subtracters to execute addition and subtraction for an operation result of the second adding/subtracting stage, generating data extended by a predetermined bit number; and
a fourth adding/subtracting stage including pluralities of adders/subtracters to execute addition and subtraction for a shifted result of the third adding/subtracting stage, generating data extended by a predetermined bit number.

2. The integer transforming device as set forth in claim 1, wherein the adder is comprised of n+1 full adders for adding first and second data of n bits,
wherein the first full adder among the n+1 full adders receives 0, and first bits of the first and second data, and outputs a sum and a carry;
wherein the second through the n'th full adders among the n+1 full adders receive the carry of the prior full adder, and the second through n'th bits respective to the first and second data, and output sums and carries, respectively; and
wherein the n+1'th full adder among the n+1 full adders receives the carry of the n'th full adder, and the n'th bits of the first and second data, and outputs a sum and a carry.

3. The integer transforming device as set forth in claim 1, wherein the subtracter is comprised of n+1 full adders for adding the first and second data of n bits,
wherein the first full adder among the n+1 full adders receives 1, and the first bits of the first and second data, and outputs a sum and a carry;
wherein the second through the n'th full adders among the n+1 full adders receive the carry respective to the prior full adders, and the second through n'th bits respective to the first and second data, and output sums and carries, respectively; and
wherein the n+1'th full adder among the n+1 full adders receives the carry of the n'th full adder, and the n'th bits of the first and second data, and outputs a sum and a carry.
